(19) United States
(12) Patent Application Publication
(10) Pub. No.: US 2024/0200932 A1
(43) Pub. Date: Jun. 20, 2024

(54) DISPLACEMENT METER INCLUDING PHOTONIC CRYSTAL COLOR CONVERSION FILM

(71) Applicant: KOREA ELECTRONICS TECHNOLOGY INSTITUTE, Seongnam-si (KR)

(72) Inventors: Sang Woong BAEK, Seoul (KR); Young Seok KIM, Seongnam-si, Gyeonggi-do (KR)

(21) Appl. No.: 18/536,447

(22) Filed: Dec. 12, 2023

(30) Foreign Application Priority Data
Dec. 15, 2022 (KR) 10-2022-0176190

(51) Int. Cl. G01B 11/14

(52) U.S. Cl. CPC G01B 11/14

(57) ABSTRACT

A displacement meter including a photonic crystal color conversion film configured to change in color in accordance with a deformation thereof, and a mechanism connected to the photonic crystal color conversion film is disclosed. The displacement meter may not only measure a pressure in a severe environment such as an outdoor environment or an underwater environment, but also may easily and conveniently measure deformation of a construction, without using a separate power supply device or separate measurement equipment.

### CROSS REFERENCE TO RELATED APPLICATION

The present application claims priority to Korean Patent Application No. 10-2022-0176190, filed Dec. 15, 2022, the entire contents of which is incorporated for all purposes by this reference.

### BACKGROUND OF THE INVENTION

### Field of the Invention

The present disclosure relates to a displacement meter including a photonic crystal color conversion film.

### Description of the Related Art

A photonic crystal is a structure in which dielectric materials having different refractive indexes are periodically arranged. The photonic crystal means a material selectively reflecting light in a particular wavelength range without allowing the light to pass therethrough in accordance with overlapping interference among light beams scattering at regular lattice points thereof.

When white light is applied to photonic crystal particles under the condition that the photonic crystal particles are aligned to have a certain arrangement in several particle layers, the photonic crystal particles, upon which the light is incident, reflect light of a particular wavelength. Such a particular wavelength, at which light is reflected, may be varied depending on spacing among the photonic crystal particles and refractive indexes of the particles and a medium in accordance with Bragg's Law.

The wavelength of the reflected light as mentioned above may be determined in accordance with vertical spacing of a plurality of photonic crystal particles. When the spacing of photonic crystal particles is great, red light of a long wavelength is reflected, whereas, when the spacing of photonic crystal particles is small, blue light of a short wavelength is reflected.

In order to utilize reflection characteristics of such photonic crystal particles, it may be possible to fabricate a photonic crystal color conversion film by dispersing photonic crystal particles in a polymer resin or the like, and then molding the polymer resin in the form of a film through a method such as extrusion or the like.

The photonic crystal color conversion film has characteristics of being easily stretchable and shrinkable in accordance with external force. Accordingly, when the film is stretched or shrunk, the spacing of photonic crystal particles of the film is varied and, as such, the color of the film is varied.

Using color conversion characteristics according to stretching and shrinkage of the photonic crystal color conversion film, it may be possible to check and measure a deformation or pressure of an object to be measured, through stretch and shrinkage of the film caused by mechanical force generated at the object.

Constructions such as a bank, a bridge, a tunnel, etc. may generate deformation due to natural ageing thereof, repeated load application thereto, etc. In order to sense and measure such mechanical deformation in conventional cases, for example, a potentiometer, a differential transformer, or an optical fiber strain gauge configured to measure a resistance variation in a metal thin film is used, or a displacement sensor configured to measure a wavelength variation caused by interference of light passing through an optical fiber and to convert the wavelength variation into a strain is used.

Such conventional displacement sensors essentially require a device for converting an electrical signal or an optical signal into a strain, and displaying the strain in the form of data, and a power supply device.

However, strain sensing and measurement for a construction should not only be periodically performed, but also be urgently performed in accordance with an on-site situation, as in an urgent situation in which urgent measurement is required or in a situation in which strain measurement should be urgently performed in accordance with situation conditions during visual inspection. In particular, there is the case in which a strain should be checked in particular and severe environments such as underwater structures, military actions, etc. In such a case, conventional displacement sensors require a time taken for preparation of a separate displacement measuring device and separate equipment for supplying electric power and, as such, fast situation checking may be difficult.

In addition, a conventional pressure meter, which is a general pressure measuring instrument, is a measuring instrument configured to measure a pressure at a point to be measured in a state of being connected to the point and to display the measured pressure as a numeral value. However, such a conventional pressure meter may check only a pressure level through the measured value.

Therefore, in order to solve the problems of the conventional displacement sensors, it is necessary to introduce a sensor capable or more rapidly checking a displacement or a pressure without requiring a separate measurement device and a power supply device.

### RELATED ART LITERATURE

### Patent Documents

Patent Document 1: KR 10-1393433B
Patent Document 2: KR 10-2021-0025453A

### SUMMARY OF THE INVENTION

Therefore, the present disclosure has been made in view of the above problems, and it is an object of the present disclosure to provide a displacement meter including a photonic crystal color conversion film.

In accordance with an aspect of the present disclosure, the above and other objects can be accomplished by the provision of a displacement meter including a photonic crystal color conversion film configured to change in color in accordance with a deformation thereof, a plurality of mechanisms respectively provided at opposite ends of the photonic crystal color conversion film, and an attachment configured to attach the mechanisms to an object to be measured, wherein the photonic crystal color conversion film is configured to change in color while being linearly deformed in linkage with generation of a displacement of the object.

In accordance with an embodiment, the mechanisms may include a first mechanism connected to one longitudinal end of the photonic crystal color conversion film, and a second mechanism connected to another longitudinal end of the photonic crystal color conversion film.

In accordance with an embodiment, the first and second mechanisms may be configured to stretch the photonic crystal color conversion film while moving away from each other.

In accordance with an embodiment, the mechanisms may further include a stopper configured to limit an approach distance between the first and second mechanisms.

In accordance with an embodiment, the mechanisms may include a first mechanism extending to one longitudinal end of the photonic crystal color conversion film while being connected to another longitudinal end of the photonic crystal color conversion film, and a second mechanism extending to the other longitudinal end of the photonic crystal color conversion film while being connected to the one longitudinal end of the photonic crystal color conversion film.

In accordance with an embodiment, the first and second mechanisms may be configured to stretch the photonic crystal color conversion film while moving toward each other.

In accordance with an embodiment, the first and second mechanisms may be disposed at the longitudinal ends of the photonic crystal color conversion film, to be slidably moved by a guide. The guide may include a guide groove and a guide protrusion respectively formed at facing surfaces of the first and second mechanisms. The guide groove may extend longitudinally in a stretching direction of the photonic crystal color conversion film, and the guide protrusion may be slidably coupled to the guide groove. The guide may further include a stopper configured to limit a spacing distance between the first and second mechanisms.

In another aspect of the disclosure, there is provided a displacement meter including a photonic crystal color conversion film configured to change in color in accordance with a deformation thereof, a mechanism connected to the photonic crystal color conversion film, to form a sealed inner space, and an injection port formed at the mechanism, to enable introduction of a fluid into the inner space, wherein the photonic crystal color conversion film is configured to change in color while being three-dimensionally deformed by a pressure of the fluid introduced into the inner space.

In accordance with an embodiment, the photonic crystal color conversion film is formed to have a hollow cylindrical shape opened at opposite ends thereof. The mechanism may include a first mechanism configured to close one opening portion of the photonic crystal color conversion film, and a second mechanism configured to close another opening portion of the photonic crystal color conversion film. The injection port may be formed at the first mechanism or the second mechanism.

In accordance with an embodiment, the mechanism may be formed to have a hollow cylindrical shape opened at one end thereof. The photonic crystal color conversion film may be connected to the mechanism, to close the opened end of the mechanism. The injection port may be formed at a cylindrical peripheral wall of the mechanism.

In accordance with an embodiment, the displacement meter may further include a color comparison table configured to enable comparison of color change states of the photonic color conversion film. The color comparison table may be configured to indicate comparative colors and percentages (%) according to the comparative colors.

Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for best explanation.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic view showing a structure of a photonic crystal color conversion film;

FIG. 2 is a schematic view showing a principle of color change in the photonic crystal color conversion film;

FIG. 3 schematically shows operation of a displacement meter including a photonic crystal color conversion film in an embodiment of the present disclosure;

FIGS. 4 and 5 schematically show an embodiment of the displacement meter including the photonic crystal color conversion film of the present disclosure;

FIGS. 6 and 7 schematically show another embodiment of the displacement meter including the photonic crystal color conversion film of the present disclosure;

FIG. 8 is a cross-sectional view taken along line I-I in FIG. 7;

FIG. 9 schematically shows application of a color comparison table to an embodiment of the displacement meter including the photonic crystal color conversion film 1 of the present disclosure;

FIGS. 10 and 11 schematically show other embodiments of the displacement meter including the photonic crystal color conversion film of the present disclosure; and

FIGS. 12 and 13 show embodiments of a connection structure for interconnecting a mechanism and a photonic crystal color conversion film in the displacement meter including the photonic crystal color conversion film of the present disclosure.

### DETAILED DESCRIPTION OF THE INVENTION

Objects, particular advantages and new features of the present disclosure will be more clearly understood from the following detailed description and preferred embodiments taken in conjunction with the accompanying drawings. However, the present disclosure is not limited to the embodiments. In the following description, when a detailed description of the relevant known function or configuration is determined to unnecessarily obscure the subject matter of the present disclosure, such detailed description will be omitted.

In the specification, in adding reference numerals for elements in each drawing, it should be noted that like reference numerals already used to denote like elements in one drawing are also used to denote the elements in another drawing wherever possible.

It should be noted that terms used herein are merely used to describe a specific embodiment, not to limit the present disclosure. Incidentally, unless clearly used otherwise, singular expressions include a plural meaning.

The drawings are not necessarily to scale and, in some instances, proportions may be exaggerated or schematically illustrated in order to clearly illustrate features of the embodiments.

It should be further understood that the terms “comprises”, “comprising,”, “has”, “having”, “includes” and/or “including”, when used herein, specify the presence of stated features (for example, integers, functions, operations, or constituent elements such as components, but do not preclude the presence of other features.

In addition, the terms “one”, “the other”, “first”, “second”, etc. are used to differentiate one constituent element from another constituent element, and these constituent elements should not be limited by these terms.

It should be understood that there is no intent to limit the embodiments described in the present disclosure and the accompanying drawings to particular forms, but on the contrary, embodiments are to cover all modifications, equivalents, and alternatives falling within the spirit and scope of embodiments.

Hereinafter, exemplary embodiments of the present disclosure will be described in detail with reference to the accompanying drawings.

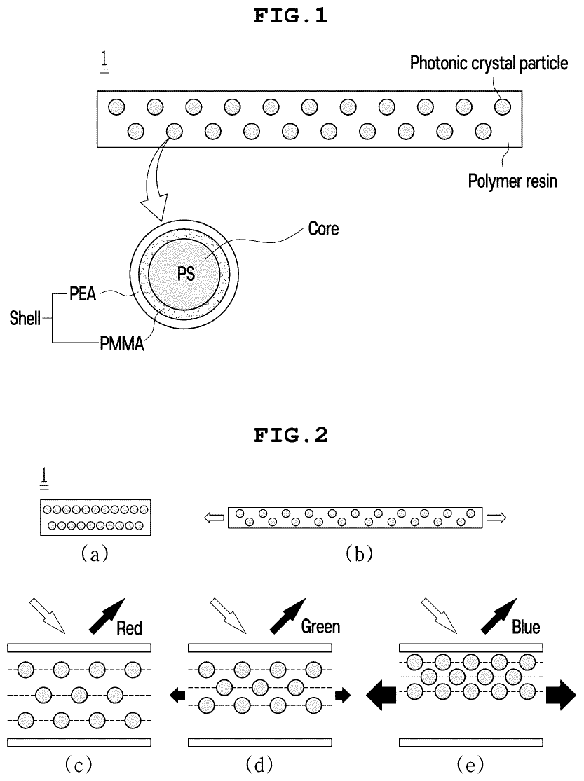

FIG. 1 schematically shows a structure of a photonic crystal color conversion film 1. The photonic crystal color conversion film 1 includes a polymer resin, and photonic crystal particles dispersed in the polymer resin in a state of being aligned with one another at a uniform spacing. Each of the photonic crystal particles may be constituted by a core made of spherical polystyrene (PS), iron oxide, etc., and a shell made of polymethyl methacrylate (PMMA), polyethylacrylate (PEA), etc. In addition, the photonic crystal color conversion film 1 should be freely stretchable and shrinkable in accordance with mechanical deformation in order to measure mechanical deformation of an object to be measured such as a construction, a structure, or the like, and should be easily fabricated in order to enable the photonic crystal particles included therein to be aligned with one another at a uniform spacing. Furthermore, the photonic crystal color conversion film 1 should have high transparency in order to prevent interference thereof with incident light. In this regard, the polymer resin may be made of a soft elastomer which may be easily molded while having high elasticity and high transparency.

FIG. 2 schematically shows a principle of color change according to stretched or shrunk deformation of the photonic crystal color conversion film 1. When the film 1 is not deformed, as shown in FIG. 2(a), the photonic crystal particles in the film 1 are aligned with one another at a uniform spacing. However, when the film 1 is laterally stretched, as shown in FIG. 2(b), the spacing of the photonic crystal particles is varied. In detail, referring to FIGS. 2(c) to 2(e), when light is incident upon the photonic crystal color conversion film 1, the photonic crystal color conversion film 1 reflects light of a particular wavelength in accordance with Bragg's Law. In this case, the wavelength of the reflected light may be varied in accordance with the spacing of the photonic crystal particles in the film 1. FIG. 2(c) shows the spacing of particles when the film 1 is not deformed. FIG. 2(d) shows the spacing of particles when the film 1 is slightly stretched. FIG. 2(e) schematically shows the spacing of particles when the film 1 is maximally stretched. It may be seen that, as the state of the film proceeds from FIG. 2(c) to FIG. 2(e), the spacing of particles is gradually reduced and, as such, the wavelength of reflected light is gradually reduced.

The photonic crystal color conversion film 1 of the present disclosure may adjust the color conversion range of photonic crystals by adjusting the spacing of photonic crystal particles and the refractive index of a medium in order to reflect light in a wavelength range visible to the naked eye. The color conversion film 1 of the present disclosure may be adjustable to reflect light of red having a longest wavelength when the film 1 is in a normal state, that is, an unstretched state, and to reflect light approximate to blue as the film 1 is stretched.

A displacement meter including the photonic crystal color conversion film 1 of the present disclosure utilizes color conversion characteristics according to deformation of the film 1 as described above. In an embodiment, the displacement meter including the photonic crystal color conversion film 1 of the present disclosure may be used to sense the case in which at least two points of an object to be measured are linearly displaced in a direction in which the two points move toward each other or away from each other. In this case, the displacement meter including the photonic crystal color conversion film 1 of the present disclosure includes a mechanism 2 attached to the object to be measured and configured to transfer a displacement of the object to the film 1. The mechanism 2 may be provided in plural. Preferably, two mechanisms 2 may be provided. The mechanism 2 may be connected to the film 1, to enable the film 1 to be stretchable. When two mechanisms 2 are provided, the two mechanisms 2 may be connected to one end of the film 1 and the other end of the film 1 opposite to the one end, respectively. For example, a plurality of mechanisms 2 (for example, plural pairs of mechanisms 2) may be connected to opposite ends of the film 1. When linear displacement is generated at the object to be measured, the photonic crystal color conversion film 1 of the present disclosure is linearly deformed through the above-described configuration and as such, may exhibit color change.

In another embodiment in which color conversion characteristics according to deformation of the photonic crystal color conversion film 1 is utilized, the displacement meter including the photonic crystal color conversion film 1 of the present disclosure may be used to sense a pressure of a particular object. In this case, the displacement meter of the disclosure may take the form of a sealed container in which the film 1 and the mechanism 2 are interconnected to form a sealed inner space therebetween. In such a sealed-container-shaped displacement meter, one surface of the container is constituted by the photonic crystal conversion film 1 of the present disclosure, and an injection port is formed at another surface of the container, at which the film 1 is not formed, for injection of a fluid for pressure measurement therethrough. The sealed-container-shaped displacement meter of this embodiment is connected to an object, to be measured, through the injection port and, as such, the surface formed with the film 1 may be three-dimensionally deformed due to a pressure of the fluid injected from the object through the injection port. Accordingly, it may be possible to measure a pressure of the object through color change according to the deformation of the film 1.

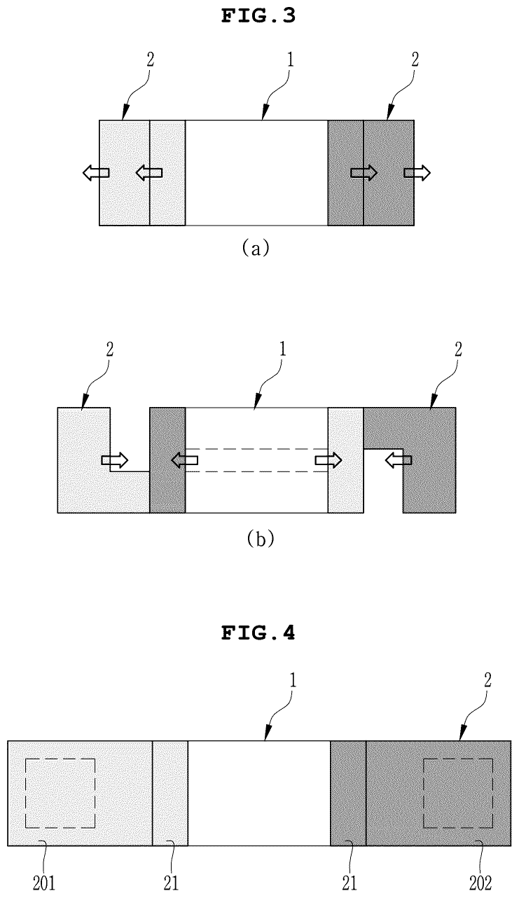

FIG. 3 schematically shows operation of the displacement meter including the photonic crystal color conversion film 1 in an embodiment of the present disclosure. FIG. 3 is associated with the case in which an object to be measured is linearly displaced. Referring to FIG. 3, it may be possible to determine a displacement of the object through color change exhibited when the photonic crystal color conversion film 1 of the present disclosure is linearly deformed. Accordingly, the displacement meter including the photonic crystal conversion film 1 of the present disclosure includes a mechanism 2 configured to deform the photonic crystal color conversion film 1 in accordance with displacement of the object. Here, the photonic crystal color conversion film 1 of the present disclosure is made of a polymer material having flexibility and elasticity, and may be molded to take the form of a flat film having a thickness of several ten μm (microns) to several mm (millimeters) while having a polygonal shape, preferably, a quadrangular shape, of several cm×cm (centimeters). The mechanism 2 may be made of plastic, metal, or the like.

Referring to FIG. 3(a), the displacement meter shown in FIG. 3(a) includes one mechanism 2 disposed at a left side (for example, a first mechanism 201 shown in FIG. 4) and another mechanism 2 disposed at a right side (for example, a second mechanism 202 shown in FIG. 4), and a film 1 connected between the mechanisms 2. The mechanisms 2 are configured such that a right end of the first mechanism 201 and a left end of the film 1 are interconnected, and a left end of the second mechanism 202 and a right end of the film 1 are interconnected. Accordingly, when a left one of the two mechanisms 2 moves leftward, and a right one of the two mechanisms 2 moves rightward (that is, when the two mechanisms 2 move away from each other), the film 1 between the two mechanisms 2 is stretched in the same directions as the movement directions of the two mechanisms 2.

In addition, referring to FIG. 3(b), the displacement shown in FIG. 3(b) includes two mechanisms 2, and a film 1 connected between the two mechanisms 2. The mechanisms 2 are configured such that a right end of one of the two mechanisms 2 disposed at a left side (for example, a first mechanism 201 shown in FIG. 4) is connected to a right end of the film 1, and a left end of the other of the two mechanisms 2 disposed at a right side (for example, a second mechanism 202 shown in FIG. 4) is connected to a left end of the film 1. Accordingly, when the left mechanism 2 moves rightward, and the right mechanism 2 moves leftward (that is, when the two mechanisms 2 move toward each other), the film 1 connected to the two mechanisms 2 and centrally disposed is stretched in directions reverse to the movement directions of the two mechanisms 2 (that is, in directions in which the two mechanisms 2 move way from each other).

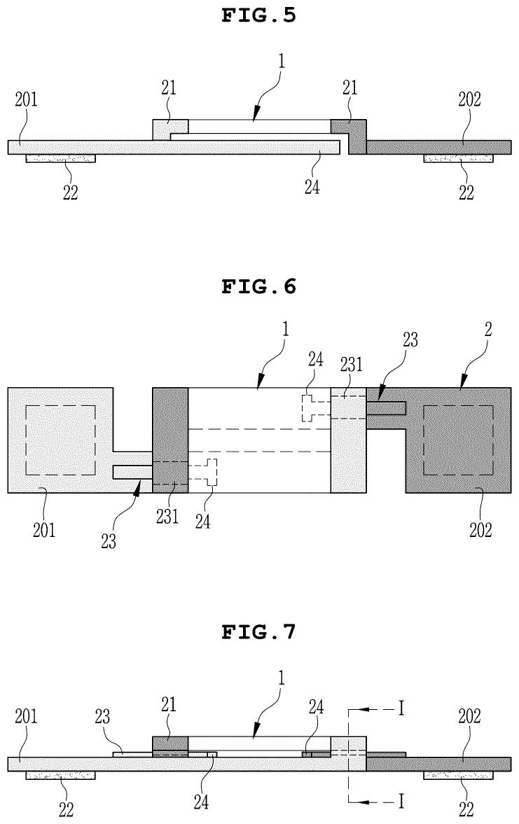

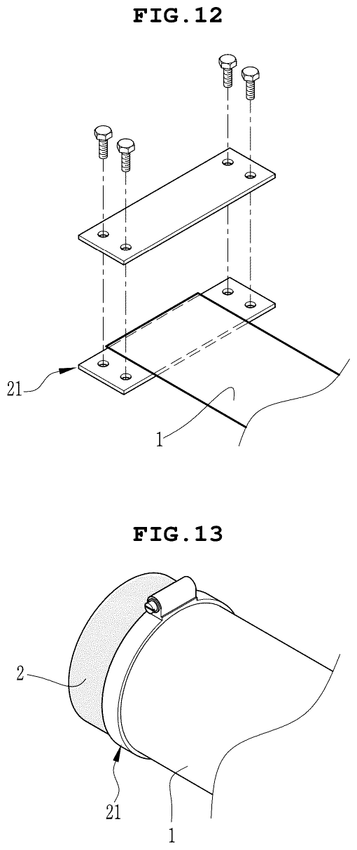

FIGS. 4 and 5 schematically show an embodiment of the displacement meter including the photonic crystal color conversion film 1 of the present disclosure. In the displacement meter shown in FIGS. 4 and 5, the photonic crystal color conversion film 1 is stretchably connected to a mechanism 2 configured in a pair such that the displacement meter is usable when an object to be measured is linearly displaced. The displacement meter operates in accordance with an operation system of the displacement meter of FIG. 3(a). The displacement meter of this embodiment is configured such that the photonic crystal color conversion film 1 and the mechanism 2 configured in a pair are interconnected, to transfer a displacement of the object to be measured to the film 1. The mechanism 2 may be constituted by a first mechanism 201 connected to one end of the photonic crystal color conversion film 1, and a second mechanism 202 connected to the other end of the photonic crystal color conversion film 1. The mechanism 2 may include a connector 21 connected to the photonic crystal color conversion film 1, and an attachment 22 configured to attach, to a displacement measurement portion of the object, the mechanism 2 connected to the photonic crystal color conversion film 1. The attachment 22 may be attached to the object using an adhesive, or may be attached to the object using a fastener such as a bolt, an anchor bolt, or the like. The connector 21 of the mechanism 2 may include clamps configured to clamp an end of the photonic crystal color conversion film 1 therebetween, thereby fastening the photonic crystal color conversion film 1 (cf. FIG. 12), or may include an adhesive coating area capable of bonding the film 1 and the connector 21 to each other through an adhesive. In this case, the first mechanism 201 and the second mechanism 202 are moved in directions in which the first mechanism 201 and the second mechanism 202 move away from each other, in accordance with deformation of the object to be measured. Accordingly, the film 1 connected to the first and second mechanisms 201 and 202 is stretched in the movement directions of the first and second mechanisms 201 and 202.

Further referring to FIGS. 4 and 5, the first and second mechanisms 201 and 202 of the mechanism 2 may be moved in accordance with displacement of the object, to which the mechanism 2 is attached, in the same directions as the stretching directions of the photonic crystal color conversion film 1. As shown in FIG. 5, the mechanism 2 may include a stopper 24 configured to limit movements of the first and second mechanisms 201 and 202 in directions reverse to the stretching directions of the film 1 (that is, shrinkage directions of the film 1). The stopper 24 is configured to cope with the case in which the object to be measured is expected to be displaced only in one direction. The stopper 24 may limit movement of the mechanism 2 in order to prevent the film 1 from being exposed to damage, etc. due to movement thereof beyond a displacement measurement range when the mechanism 2 is moved in a direction reverse to the displacement direction of the object to be measured. For example, in the displacement meter including the photonic crystal color conversion film 1 in the embodiment of FIGS. 4 and 4, the mechanism 2 includes the stopper 24, which lengthily extends such that one end of the first mechanism 201 is disposed near the second mechanism 202, in order to prevent the first and second mechanisms 201 and 202 from moving toward each other beyond a predetermined distance. Thus, the stopper 24 prevents the first and second mechanisms 201 and 202 of the mechanism 2 from moving beyond a predetermined distance when the first and second mechanisms 201 and 202 move toward each other in shrinkage directions of the film 1.

FIGS. 6 and 7 schematically show another embodiment of the displacement meter including the photonic crystal color conversion film 1 of the present disclosure. The mechanism 2 shown in FIGS. 6 and 7 operates in accordance with an operation system of the displacement meter of FIG. 3(b). This displacement meter may be constituted by the photonic crystal color conversion film 1, and a mechanism 2 configured in a pair. The mechanism 2 may be constituted by a first mechanism 201 connected to one end of the photonic crystal color conversion film 1, and a second mechanism 202 connected to the other end of the photonic crystal color conversion film 1. The mechanism 2 may include connectors 21 connected to the photonic crystal color conversion film 1, and attachments 22 configured to be attached to displacement measurement portions of an object to be measured, respectively. Each attachment 22 may be attached to the object using an adhesive, or may be attached to the object using a fastener such as a bolt, an anchor bolt, or the like. Each connector 21 of the mechanism 2 may include clamps configured to clamp an end of the photonic crystal color conversion film 1 therebetween, thereby fastening the photonic crystal color conversion film 1 (cf. FIG. 12), or may include an adhesive coating area capable of being bonded to the mechanism 2 through an adhesive. In this case, in accordance with deformation of the object, the first mechanism 201 may be moved rightward, and the second mechanism 202 may be moved leftward and, as such, the first and second mechanisms 201 and 202 may move toward each other. Accordingly, the film 1 is stretched in directions reverse to the movement directions of the first and second mechanisms 201 and 202 (that is, directions in which the first and second mechanisms 201 and 202 move away from each other).

Further referring to FIGS. 6 and 7, the first and second mechanisms 201 and 202 of the mechanism 2 may be configured to be moved in accordance with displacement of the object, to which the mechanism 2 is attached, in directions reverse to deformation directions of the photonic crystal color conversion film 1. The first and second mechanisms 201 and 202 of the mechanism 2 are arranged to move under the condition that one-side ends thereof vertically overlap each other. Accordingly, when the first and second mechanisms 201 and 202 of the mechanism 2 move toward each other, respective connectors 21 of the first and second mechanisms 201 and 202 are moved away from each other. The first and second mechanisms 201 and 202 may include respective guides 23 configured to guide movement of the first and second mechanisms 201 and 202. The guides 23 may function to guide the first and second mechanisms 201 and 202 such that the first and second mechanisms 201 and 202 slidably move under the condition that the first and second mechanisms 201 and 202 engage with each other while vertically overlapping each other. In addition, the mechanism 2 may include stoppers 24 configured to limit movements of the first and second mechanisms 201 and 202 in directions reverse to the stretching directions of the film 1 (that is, shrinkage directions of the film 1).

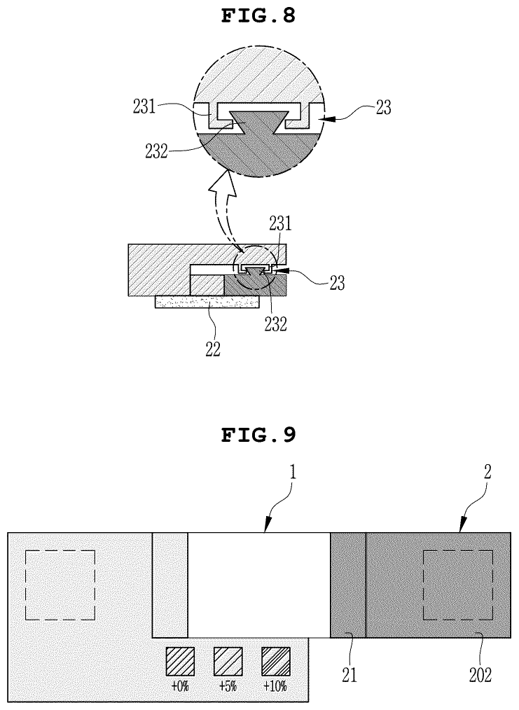

FIG. 8 is a cross-sectional view taken along line I-I in FIG. 7. As shown in FIG. 8, each guide 23 may be longitudinally formed at facing surfaces of the first and second mechanisms 201 and 202 vertically overlapping each other. Each guide 23 may be constituted by a guide groove 231 having a slot, and a guide protrusion 232 slidably coupled to the guide groove 231 in a state of longitudinally engaging with the guide groove 231. The guide groove 231 and the guide protrusion 232 are interconnected in a state of engaging with each other, to enable the guide groove 231 and the guide protrusion 232 to longitudinally slide with respect to each other. The guide groove 231 and the guide protrusion 232 may also have shapes preventing the facing surfaces of the first and second mechanisms 201 and 202 of the mechanism 2 from being vertically separated from each other. For example, each guide 23 of FIGS. 6 to 8 may include a guide protrusion 232 having a predetermined longitudinal length at a corresponding one of respective upper surfaces of the first and second mechanisms 201 and 202, and a guide groove 231 having a shape corresponding to that of the guide protrusion 232 at a corresponding one of respective lower surfaces of the first and second mechanisms 201 and 202 facing the guide protrusion 232. In this case, the guide groove 321 may slide along the guide protrusion 232 in a state of engaging with the guide protrusion 232. On the contrary, for example, each guide 23 may include a guide groove 231 having a predetermined longitudinal length at a corresponding one of respective upper surfaces of the first and second mechanisms 201 and 202, and a guide protrusion 232 having a shape corresponding to that of the guide groove 231 at a corresponding one of respective lower surfaces of the first and second mechanisms 201 and 202 facing the guide groove 231. In addition, a stopper 24 may be formed at one longitudinal end of the guide protrusion 232 or the guide groove 231, to be brought into contact with the guide groove 231 or the guide protrusion 232, thereby preventing the guide groove 231 or the guide protrusion 232 from escaping.

FIG. 9 schematically shows application of a color comparison table 3 to an embodiment of the displacement meter including the photonic crystal color conversion film 1 of the present disclosure. The color comparison table 3 quantitatively predetermines displacements of an object, to be measured, according to predetermined color variations. It may be possible to measure a displacement of the object through comparison of a color represented by the film 1 in accordance with the color comparison table 3. For example, the color comparison table 3 may indicate an initial state, in which there is no displacement of the object, by a percentage of 0%, and ratios of displacements of the object with respect to the initial state by percentages of 5%, 10%, 20%, etc. The color comparison table 3 may be previously set to indicate a color varying in accordance with a displacement ratio, together with the displacement ratio, for example, red in the case of 0% corresponding to the initial state, yellow in the case of 5%, and green in the case of 10%. Through the color comparison table 3, it may be possible to quantitatively check a color variation of the photonic crystal color conversion film 1 of the present disclosure and a displacement of the object according to the color variation. The color comparison table 3 as described above may be disposed at any position of one of the first and second mechanisms 201 and 201 in the mechanism 2 including the photonic crystal color conversion film 1 of the present disclosure.

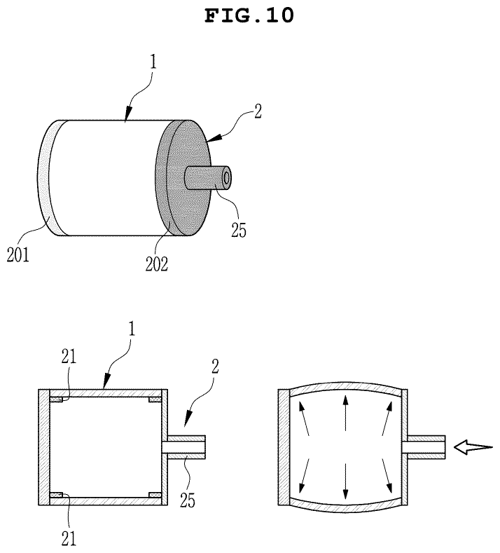

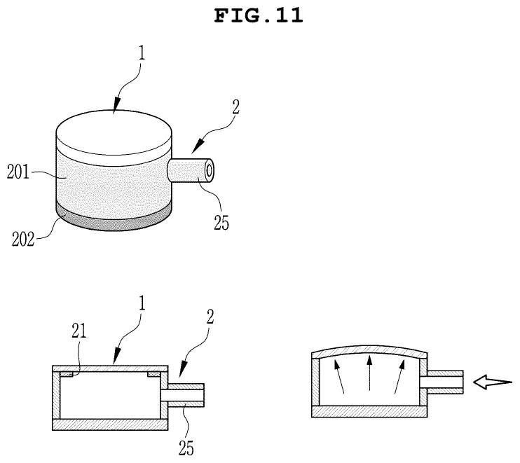

FIGS. 10 and 11 schematically show other embodiments of the displacement meter including the photonic crystal color conversion film 1 of the present disclosure. In such cases, the displacement meter including the photonic crystal color conversion film 1 of the present disclosure takes the form of a sealed cylindrical container, for pressure sensing, and one surface of the sealed container is constituted by the photonic crystal color conversion film 1 of the present disclosure. The film 1, which forms one surface of the displacement meter as described above, is connected to a mechanism 2 and, as such, forms a sealed cylindrical inner space. One of first and second mechanisms 201 and 202 of the mechanism 2 may include an injection port 25 configured to form a passage for supplying a fluid into the sealed inner space. The displacement meter of this embodiment may measure a pressure of the fluid injected into the sealed inner space through the injection port 25 by previously quantitatively setting references of color variations of the film 1 generated in accordance with variations of a pressure of the fluid applied to the film 1 at one surface of the sealed inner space, and visually discriminating a variation in color exhibited as the photonic crystal color conversion film 1 is three-dimensionally deformed in accordance with the pressure of the fluid. In such a pressure measurement mechanism, a predetermined color comparison table 3 may be attached to one surface of the mechanism 2 and, as such, may be used as a pressure reference table.

In the displacement meter of the embodiment shown in FIG. 10, which includes the photonic crystal color conversion film 1 of the present disclosure, the photonic crystal color conversion film 1 is connected between the first and second mechanisms 201 and 202 of the mechanism 2, thereby forming a sealed cylindrical container. That is, a peripheral wall of the sealed cylindrical container is constituted by the film 1. The injection port 25 is formed at the second mechanism 202 corresponding to one lateral wall of the cylindrical container, for example, a bottom of the cylindrical container. The film 1 is three-dimensionally deformed in accordance with a pressure of the fluid injected through the injection port 25 and, as such, color change is generated. The first and second mechanisms 201 and 202 of the mechanism 2 include connectors 21 configured to connect the first and second mechanisms 201 and 202 to the photonic crystal color conversion film 1, respectively. The photonic crystal color conversion film 1 may be bonded to the connectors 21 of the sealed pressure container by an adhesive. Alternatively, as shown in FIG. 13, the photonic crystal color conversion film 1 may be connected to the mechanism 2 using clamps respectively configured to clamp portions of the film 1 contacting the connectors 21 while surrounding the film portions, thereby fastening the film 1.

The displacement meter of the embodiment shown in FIG. 11, which includes the photonic crystal color conversion film 1 of the present disclosure, takes the form of a cylindrical container, similarly to that of FIG. 10, and the photonic crystal color conversion film 1 thereof constitutes a top of the cylindrical container, and is connected to the first mechanism 201 constituting a peripheral wall of the cylindrical container. In addition, a bottom of the cylindrical container is constituted by the second mechanism 202, and is connected to the first mechanism 201, thereby forming a sealed cylindrical container. The injection port 25 is formed at the first mechanism 201. The film 1 is deformed in accordance with a pressure of the fluid injected through the injection port 25 and, as such, color change is generated. A connector 21 may be formed in a region where the first mechanism 201 and the film 1 are interconnected. The connector 21 may be formed to protrude from an inner peripheral surface of the cylindrical container adjacent to a top surface of the first mechanism 201, or may be formed at an outer peripheral surface of the cylindrical container adjacent to the top surface of the first mechanism 201. The photonic crystal color conversion film 1 may be bonded to the connector 21 by an adhesive. Alternatively, as shown in FIG. 13, the photonic crystal color conversion film 1 may be connected to the mechanism 2 using clamps respectively configured to clamp a portion of the film 1 at the connector 21 formed at the outer peripheral surface of the first mechanism 201 while surrounding the film portion, thereby fastening the film 1.

FIGS. 12 and 13 show embodiments of a connection structure for interconnecting the mechanism 2 and the photonic crystal color conversion film 1 of the present disclosure in the displacement meter including the photonic crystal color conversion film 1. FIG. 12 shows a clamping structure in which the film 1 is fastened between two clamps fastened by a bolt or the like and, as such, the film is fixed. The clamping structure of FIG. 12 may be used in the displacement meters shown in FIGS. 4 to 7. FIG. 13 shows a clamping structure in which the film 1 is fastened by a ring-shaped fastener configured to surround the connector 21 of the mechanism 2, using a fastening force of a bolt and, as such, the film 1 is fixed. The clamping structure of FIG. 13 may be used in the displacement meter of FIGS. 10 and 11 including a sealed cylindrical inner space.

Although not shown, the displacement meter including the photonic crystal color conversion film 1 of the present disclosure may include the photonic crystal color conversion film 1, which is formed to have various shapes such as a quadrangular shape, a polygonal shape, a circular shape, etc., and the mechanism 2 configured in plural pairs and connected to the film 1. The mechanism 2 provided in plural pairs may be configured to move in multiple directions in accordance with a deformation direction of the film 1. The displacement meter including the photonic crystal color conversion film 1 and the mechanism 2 configured in plural pairs, as described above, may be attached to an object, to be measured, which is not specified in deformation direction, and, as such, may easily measure a deformation direction of the object and a strain according to the deformation direction.

As apparent from the above description, through the displacement meter including the photonic crystal color conversion film of the present disclosure, it may be possible to easily and conveniently check and measure, on-site, a strain of a structure or a pressure of an object to be measured, without using a separate power supply device or measurement equipment. In addition, a strain or a pressure is indicated through color change of the film and, as such, may be easily sensed with the naked eye and may be rapidly and clearly checked by an unskilled user. In particular, the displacement meter exhibits excellent utility in a severe environment such as an underwater environment because the displacement meter may achieve a desired measurement without using a power supply device.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

Simple modifications and alterations fall within the scope of the disclosure, and the protection scope of the disclosure will be apparent from the appended claims.

What is claimed is:

1. A displacement meter comprising:
a photonic crystal color conversion film configured to change in color in accordance with a deformation thereof;
a plurality of mechanisms respectively provided at opposite ends of the photonic crystal color conversion film; and
an attachment configured to attach the mechanisms to an object to be measured,
wherein the photonic crystal color conversion film is configured to change in color while being linearly deformed in linkage with generation of a displacement of the object.

2. The displacement meter according to claim 1, wherein the mechanisms comprise:
a first mechanism connected to one longitudinal end of the photonic crystal color conversion film; and
a second mechanism connected to another longitudinal end of the photonic crystal color conversion film.

3. The displacement meter according to claim 2, wherein the first and second mechanisms are configured to stretch the photonic crystal color conversion film while moving away from each other.

4. The displacement meter according to claim 3, wherein the mechanisms further comprise a stopper configured to limit an approach distance between the first and second mechanisms.

5. The displacement meter according to claim 1, wherein the mechanisms comprise:
a first mechanism extending to one longitudinal end of the photonic crystal color conversion film while being connected to another longitudinal end of the photonic crystal color conversion film; and
a second mechanism extending to the other longitudinal end of the photonic crystal color conversion film while being connected to the one longitudinal end of the photonic crystal color conversion film.

6. The displacement meter according to claim 5, wherein the first and second mechanisms are configured to stretch the photonic crystal color conversion film while moving toward each other.

7. The displacement meter according to claim 6, wherein:
the first and second mechanisms are disposed at the longitudinal ends of the photonic crystal color conversion film, to be slidably moved by a guide;
the guide comprises a guide groove and a guide protrusion respectively formed at facing surfaces of the first and second mechanisms;
the guide groove extends longitudinally in a stretching direction of the photonic crystal color conversion film, and the guide protrusion is slidably coupled to the guide groove; and
the guide further comprises a stopper configured to limit a spacing distance between the first and second mechanisms.

8. A displacement meter comprising:
a photonic crystal color conversion film configured to change in color in accordance with a deformation thereof;
a mechanism connected to the photonic crystal color conversion film, to form a sealed inner space; and
an injection port formed at the mechanism, to enable introduction of a fluid into the inner space,
wherein the photonic crystal color conversion film is configured to change in color while being three-dimensionally deformed by a pressure of the fluid introduced into the inner space.

9. The displacement meter according to claim 8, wherein:
the photonic crystal color conversion film is formed to have a hollow cylindrical shape opened at opposite ends thereof;
the mechanism comprises a first mechanism configured to close one opening portion of the photonic crystal color conversion film, and a second mechanism configured to close another opening portion of the photonic crystal color conversion film; and
the injection port is formed at the first mechanism or the second mechanism.

10. The displacement meter according to claim 8, wherein:
the mechanism is formed to have a hollow cylindrical shape opened at one end thereof;
the photonic crystal color conversion film is connected to the mechanism, to close the opened end of the mechanism; and
the injection port is formed at a cylindrical peripheral wall of the mechanism.

11. The displacement meter according to claim 1, further comprising:
a color comparison table configured to enable comparison of color change states of the photonic color conversion film,
wherein the color comparison table is configured to indicate comparative colors and percentages (%) according to the comparative colors.

12. The displacement meter according to claim 8, further comprising:
a color comparison table configured to enable comparison of color change states of the photonic color conversion film,
wherein the color comparison table is configured to indicate comparative colors and percentages (%) according to the comparative colors.
